(19) United States
(12) Patent Application Publication
(10) Pub. No.: US 2014/0309004 A1
(43) Pub. Date: Oct. 16, 2014

(54) Method and system for interpersonal challenging

(71) Applicant: Mashhur Zarif Haque, Lawrence, KS (US)

(72) Inventor: Mashhur Zarif Haque, Lawrence, KS (US)

(21) Appl. No.: 13/986,221

(22) Filed: Apr. 15, 2013

(51) Int. Cl. A63F 13/30; G06Q 50/34; G06Q 30/02; G06Q 50/00

(52) U.S. Cl. CPC A63F 13/12; G06Q 50/01; G06Q 50/34; G06Q 30/0269
USPC 463/9

(57) ABSTRACT

A web hosting platform is invented to provide advertisement and promotional services of sellers of goods and services to a targeted group of people who congregate to this platform depending on their common interests that translates into common consumption preferences. This platform uses a very pervasive human behavior, interpersonal challenging and is meant to benefit the consumers and sellers of goods and services and create a revenue stream for the web hosting agencies based on an innovative business model.

### TECHNICAL FIELD OF INVENTION

The invention relates to facilitating interpersonal private and public social challenges and wagers people give and take routinely in the conduct of many aspects of their lives.

### BACKGROUND OF THE INVENTION

Interpersonal betting is a very pervasive human behavior that promotes connectivity, keeping in touch, conversation, nurturing of common interests and friendships. Golf players may love to discuss golfing, engineers may look for an outlet to discuss engineering subjects, and basket ball lovers may congregate around basket ball topics. Common interests may harbor agreements and disagreements among people which could ultimately lead to throwing challenges to one another.

An interpersonal wager based on motivating loved ones to excel say in education could be, for example, a daughter who is a senior in a high school could challenge her father by wagering that if she could score more than 32 in Medical Collegiate Admission Test (MCAT) her father would buy her a new car or else she would enroll in an in-state university and live at home with parents if possible. The father could accept this challenge. If the daughter who originated the bet wanted to include many others in her extended family, she could open the betting asking for additional winnings to pay for expenses in her medical education. A husband and his pregnant wife could have a disagreement about the name of their yet unborn child, husband selecting one name and wife going for another. The two could however agree to put the two names up for voting by their friends and relatives. Whoever wins more votes wins the wager. The winning could be a whole body message for the winner by the loser. These types of interpersonal challenges and wagers could have an internet forum as a venue for people to congregate to from across the country and outside the country to the extent allowed by laws of the land.

The above bettings immediately reveal certain consumption traits of the betting participants. The participants have clearly revealed that they are interested in a car and other goods and services required by a prospective medical student and they are also planning to welcome a new baby in the family and like whole body messages. Vendors who are in the business of catering to the needs of these consumers will have a group of captive audience and a very good platform to advertise and promote their goods and services including free and discounted offerings to a very interested, well targeted, and captive audience.

Advertising costs is a big component of cost of goods and services sold by the sellers. Advertising via print media, TV and radio are diffused. Internet advertising if not done properly is also diffused. Print media disseminates the ads to all audiences irrespective of whether the reader is interested in the ads or not. Consequently, costs of ads are usually high.

Therefore, a need exists to determine people's consumption behavioral traits and interests directly or indirectly by providing people platforms to group together and congregate based on their common interests e.g. interest in politics, sports, economics, stock markets, fishing, hunting, music, and vocations to name only a few. “A Method and System for Interpersonal Challenging” in accordance with the present invention provides such a platform for people with common interests to congregate, indirectly creating a place to market goods and services that interest the consumers. In this platform, consumers indirectly reveal their consumption behavior for the vendors to detect the needs and preferences of the consumers which will greatly enhance the effectiveness of ads and reduce the advertisement costs of goods and services sold. The advertising cost saving could translate into savings for the consumers.

### BRIEF SUMMARY OF THE INVENTION

The problems outlined above are in large measure solved by “A Method and System for Interpersonal Challenging” in accordance with the present invention. A method and system are provided to utilize human behavior of interpersonal challenging to the good use of better serving the consumers through targeted ads via internet and reduction of advertisement costs.

More specifically, a method and system for facilitating interpersonal challenging has been invented. The invention uses fixed and mobile devices through an internet based communication, dissemination, monitoring and rewarding of interpersonal private and public social challenge and wagering. Consumers will have a venue to congregate to carry conversation and challenge one another, based on their interest areas such as but not limited to politics, music, sports, fishing, hunting, stock market, vocations etc. Providers of consumer goods and services that cater to the particular interest areas revealed through the interpersonal challenges of the congregated consumers will have an easy access to this marketing venue. Advertising in this market place will be very efficient and effective. The vendors will be given access to this market place to showcase, promote and sell their products through the system in accordance with this invention.

### DETAILED DESCRIPTION OF THE INVENTION

The system has a free of cost Registration Module that will capture some personal information of the people who want to use the system. In exchange of the consumer's having the privilege of using this system, the consumer will be asked to provide some personal information such as names, address, telephone number, email address etc. that will allow the system and the consumer to communicate with each other seamlessly. The system has been developed to integrate these and other information to create a data base of any willing participant of the wagering process which will indirectly or directly capture the participant's consumption data and preferences of different consumer goods and services. The Registration Module also customizes interpersonal challenging community by interest areas such as but not limited to finance, sports, science, and general etc.

Another module, Wager Module is dedicated to broadcast social challenges or wagering originating from a person including a member of a family or an extended family, a friend, an acquaintance or any other person inviting other members of a family or an extended family, friends, acquaintances or any other persons with originator's ability to send open challenges on originator's own terms to anyone in the friend circle. The originator of the challenge will have the means to (1) broadcast the challenge to receivers, such as family members, relatives, friends and acquaintances and any other persons whose contact are known to the originator and (2) invite receivers to participate in the wagering. Any receiver who wants to participate in wagering will register through the free of cost Registration Module by providing the information requested in the Registration Module. Once registered, the receiver could now participate in the wagering. This receiver in turn could become an originator by formulating his own new challenge or counter wager, set expirations and invite others to join in the new wager. This module has been designed to regularly self-update for each registrant to view current challenges of those in the wagering community, and to send text, email and proprietary notification to any individual in the community.

A Vendor Module is an integral part of this invention. The function of this module is to extract information provided by the Registration Module and the Wager Module, and analyze the information, screen and determine the matching of interests between the consumers and the vendors. Once a match is detected, this module communicates to vendors informing that (1) a group of consumers has congregated to the market place provided by this invention, and (2) these consumers display the interests in goods and services the communication receiving vendors could provide. The vendors then advertise and promote their goods and services to the consumers enticing them with free offerings, sales and many discounted offerings.

The invention is concerned with interpersonal challenging in the first place. So, the invention includes a Winning Reward Module that keeps record of what a particular challenging bets on (the bet could be goods and services, money or simply some points), who the challenge originator is, who the challenge takers are, who the winners of the bet are and many other relevant statistics. Alternatively, the winners of the bet could simply earn some points which need to be recorded also for eventual conversion of the earned points into tangible goods and services offered by the participating vendor(s) or money.

An Account Module keeps record of the winners and losers of the wager and their cumulative earned points. This module also puts cash/virtual money in to send to winners and has provisions to pre-purchase goods and services to wager rather than wager on “Credit”.

A Challenge and Wager Analysis Module is designed to auto-match wagers to ad coupons offerings that allow purchase and pre-purchase of wager items on the spot, determine users interest and to provide for be counter wagering opportunity.

A Rating-system Module takes payments, keep records of time to respond, cancellation statistics, feedback, and more information to give a “credit” or “wagerer” rating to the participants.

A Promotional Video Module allows the vendors to advertise the goods and services the vendor(s) who awarded the winning reward to the winners of the wager.

A User Voting Module allows the wagering participants to assess acceptability of a subject, build consensus and voting on a subject on the wall.

Finally, the system has a Statistics Module to record information such as but not limited to wins, loses, and number of bets etc.

What is claimed is:

1. A method and system for interpersonal challenging via an internet based communication, dissemination, monitoring and rewarding of interpersonal private and public social challenge and wagering in the form of rewards of goods and services and money through fixed and mobile devices comprising:
a Registration Module to create a data base of any willing participant of the wagering process free of any cost to the participant in exchange of the participant's providing a set of well defined personal information such as names, address, telephone number, email address etc. that will facilitate the system and the consumer to communicate with each other seamlessly with a view to indirectly or directly capture the participant's consumption data and preferences of different consumer goods and services and to customize participants' community by interest areas such as but not limited to politics, finance, sports, engineering, science, vocations and general;
a Wager Module to broadcast a social challenge or wagering originating from a person including a member of a family or an extended family, a friend, an acquaintance or any other person inviting other members of a family or an extended family, friends, acquaintances or any other persons to participate in the wagering with originator's ability to send open challenges on originator's own terms for anyone in the friend circle to see with the built-in capacity for (1) the invited persons to formulate their own wagers and counter wagers after their registration into the system of this invention and (2) the system to self update regularly for each registrant to view current challenges of those in the wagering community, and to send text, email and proprietary notification to any individual in the community;
a Vendor Module to (1) extract information provided by the Registration Module and the Wager Module, (2) analyze the information, (3) screen and determine the matching of interests between the consumers and the vendors (4) communicate to vendors informing (a) that a group of consumers has congregated to the market place provided by this invention, and (b) the data base of participant's preferences for different consumer goods and services allowing the vendors to advertise and promote their goods and services to the consumers enticing them with free and discounted offerings and sales;
a Winning Reward Module to keep record of each (1) betting challenge including the betted goods and services, money or points (2) betting originator (3) challenge taker (4) conversion of earned points into tangible goods and services and (5) matching of goods and services with the vendors;
an Account Module to keep record of each winner and each loser and cumulative earned points of each, to put cash/virtual money in to send to winners and to provide for pre-purchase of goods and services to wager rather than wager on credit;
a Challenge and Wager Analysis Module to auto-match wagers to ad coupon offerings that allow purchase and pre-purchase of wager items on the spot, determine users interest and to provide for the ability to counter wagering;
a Rating System Module to take payments, keep records of time to respond to the betting and cancellation statistics, to provide for feedback and information to give credit and to provide for the ability to rate a particular wagerer;
a Promotional Video Module to allow the vendors to advertise the goods and services of the vendor(s) who awarded the winning rewards to the winners of the wager;
a User Voting Module to assess acceptability of a subject, build consensus and voting on a subject on the wall; and
a Statistics Module to record information such as but not limited to wins, loses, and number of bets.

2. The Registration Module of claim 1, is further adapted to provide the registrant an ability to sign up on the fly via Face Book, Phone, email, sms, Twitter and an ability to the new invited user to accept a challenge.

3. The system of claim 1, is further adapted to provide ability to notify through text messages new challenges and updates of challenges which are being followed by the participant.

4. The system of claim 1, is further adapted to monetize the winning rewards and promotional video into a revenue stream from the vendors in exchange of having access to an advertisement medium by the vendors.

5. The system of claim 1, is further adapted to serve as the basis of a revenue earning operation for the holder of the right of operation of system of claim
